(19) United States
(12) Patent Application Publication
(10) Pub. No.: US 2012/0068037 A1
(43) Pub. Date: Mar. 22, 2012

(54) MULTI-LAYER PAPER STRUCTURES AND PROCESSES OF PRODUCING THE SAME

(76) Inventor: Joshua Johnson, Green Bay, WI (US)

(21) Appl. No.: 12/887,261

(22) Filed: Sep. 21, 2010

(51) Int. Cl. A47B 97/04; B32B 38/06; B32B 38/14; B32B 38/04

(52) U.S. Cl. 248/444.1; 248/441.1; 248/450; 156/256; 156/219

(57) ABSTRACT

Multi-layer paper structures and processes of producing the same are described. An easel includes a backer layer associated with a first web roll, the backer layer comprising a planar portion and a support structure and a display layer associated with a second web roll different from the first web roll, the display layer comprising a front face and a back face, the back face coupled to the backer layer. The front face includes information associated with a recipient of the easel or an organization.

### FIELD OF THE DISCLOSURE

This patent relates to multi-layer paper structures and, more particularly, to multi-layer paper structures and methods of producing the same.

### BACKGROUND

Easels may be used in different applications to display information. In some instances, easels are produced using a sheet of material that is folded over itself.

### BRIEF DESCRIPTION OF THE DRAWINGS

FIGS. 1-3 depict different view of an example easel.

FIG. 4 depicts another example easel.

FIG. 5 depicts another example easel.

FIGS. 6-14 depict processes of producing the examples described herein, wherein the processes may be implemented using machine-readable instructions.

FIG. 15 is a schematic illustration of an example processor platform that may be used and/or programmed to implement any or all of the example processes described herein.

FIGS. 16-18 depict examples of producing the examples described herein.

### DETAILED DESCRIPTION

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness. Additionally, several examples have been described throughout this specification. Any features from any example may be included with, a replacement for, or otherwise combined with other features from other examples.

The examples described herein relate to example easels and methods or processes of producing example easels in an in-line manufacturing process. The easels may include any number of layers such as two layers, three layers, four layers, etc. each associated with a different web rolls. In some examples, one or more processes may be performed on the different layers prior to mating (e.g., coupling) the layers together. In some examples, one or more processes may be performed on the different layers after mating two or more of the layers together. Some of the processes may include die cutting to define different structure(s) and/or opening(s), imaging, printing, adding one or more additional features, applying adhesive, trimming, cutting, etc.

In some examples, one of the layers may be a backer layer having a support structure (e.g., a vertical support, a horizontal support) to enable the easel to be supported in a substantially upright position. In some examples, the backer layer may define an opening or aperture to enable the easel to be hung and/or suspended. In some examples, one of the layers may be a display layer including information printed and/or imaged thereon. In some examples, one of the layers may be a poly or substantially transparent layer to protect (e.g., prevent scratching, damage, etc.) the information and/or document being displayed. In some examples, one of the layers may be a frame layer surrounding a perimeter of the easel. In some examples, one or more of the layers may be a label layer such as, for example, a ribbon layer.

In some examples, easels having a first number of layers (e.g., 2, 3, 4, etc.) and/or characteristics (e.g., one or more additional features) and associated with a first customer and/or run may be produced and, thereafter, easels having a second number of layers (e.g., 2, 3, 4, etc.) and/or characteristics (e.g., one or more additional features) and associated with a second customer and/or run may be produced. In some examples, easels having the same number of layers but having different characteristics may be sequentially produced.

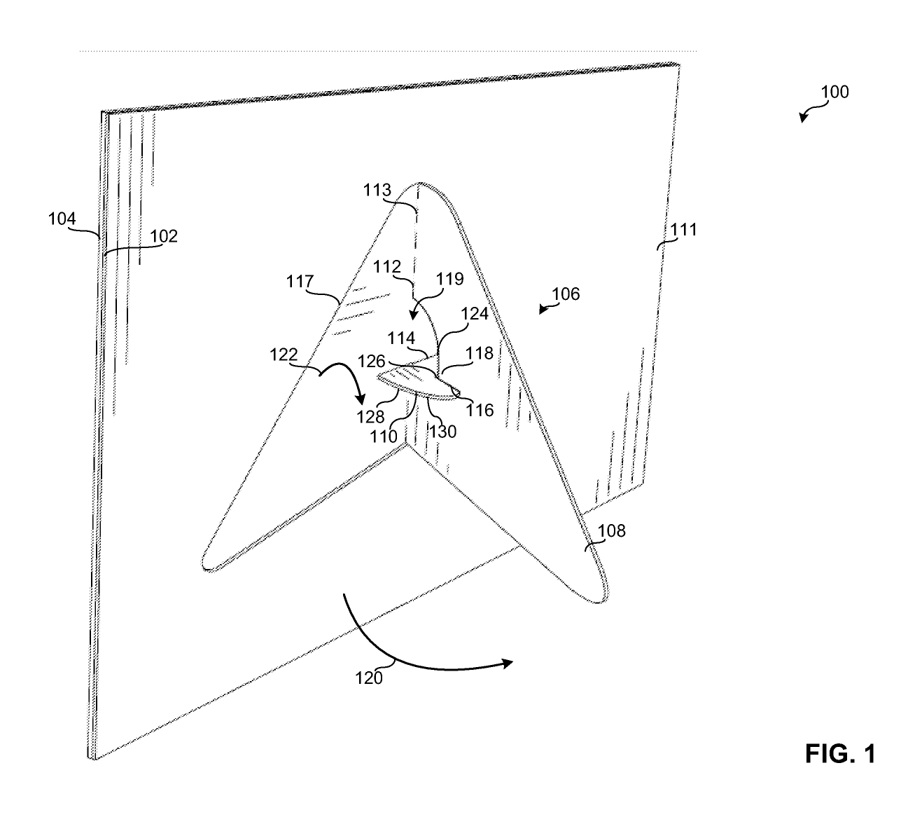

FIG. 1 depicts an example easel 100 such as an in-line easel or a self standing easel. The example easel 100 may be used to display any type of information such as a certificate, a recognition, a calendar and/or other advertisement(s) or information. In some examples, the information may be associated with a recipient of the easel 100 or an organization.

The easel 100 includes an example easel backer or first layer 102 cut from and/or associated with a backer web roll. The easel 100 also includes an example display component or second layer 104 cut from and/or associated with a display web roll. In some examples, the layers 102 and 104 may be coupled together by applying adhesive or paste to a front face of the first layer 102 and coupling a back face of the second layer 104 thereto. Alternatively, the adhesive or paste may be applied to the second layer 104. The first and second layers 102 and 104 may have similar or different thicknesses and may be made of one or more similar or more different materials and/or substrates. The materials may include paper, plastic, etc. The first layer 102 may include a support structure 106 to enable the easel 100 to be supported somewhat upright on a substantially horizontal surface, such as a tabletop. The second layer 104 may include text, graphics and/or images that may at least partially be personalized for an individual, for example. In some examples, the second layer 104 may include one or more additional features. The additional features may include varnish (e.g., UV varnish), label(s) (e.g., blow on labels), embossing, etc. To cure the UV varnish if applied, the second layer 104 may be exposed to lamps and/or fans etc.

In one example, the support structure 106 includes a vertical support 108 and a horizontal support 110. The vertical support 108 is hingably coupled to a planar portion 111 of the first layer 102 along a first fold or hinge 112. The first fold 112 may include one or more perforations 113, scoring, or may be otherwise weakened. The vertical support 108 may be cut from the first layer 102 along line 117. Thus, the vertical support 108 may be fabricated from the first layer 102. The horizontal support 110 is coupled to the planar portion 111 along a second fold or hinge 114. The horizontal support 110 defines an opening or slit 116 through which an inner portion 118 of the vertical support 108 is to be positioned. In some examples, the interaction between the slit 116 and the inner portion 118 secures the vertical support 108 substantially perpendicularly relative to the planar portion 111. In other examples, the easel 100 may not be provided with the horizontal support 106 and/or the vertical support 108. Instead, in some examples, the first layer 102 may define an opening or aperture to enable the example easel 100 to be hung and/or suspended.

In practice, to position and/or deploy the support structure 106 relative to the easel 100, a person may move the vertical support 108 in a direction generally indicated by arrow 120 until the vertical support 108 is positioned substantially perpendicularly relative to the planar portion 111. The horizontal support 110 is then moved within an opening or aperture 119 defined by and/or between the vertical support 108 and the second layer 104 in a direction generally indicated by arrow 122. As the horizontal support 110 is moved toward the inner portion 118, the inner portion 118 enters the slit 116 until an edge 124 of the inner portion 118 engages an end 126 of the slit 116 and a lower surface 128 of the horizontal support 110 engages a surface (e.g., a flat surface) 130 of the vertical support 108.

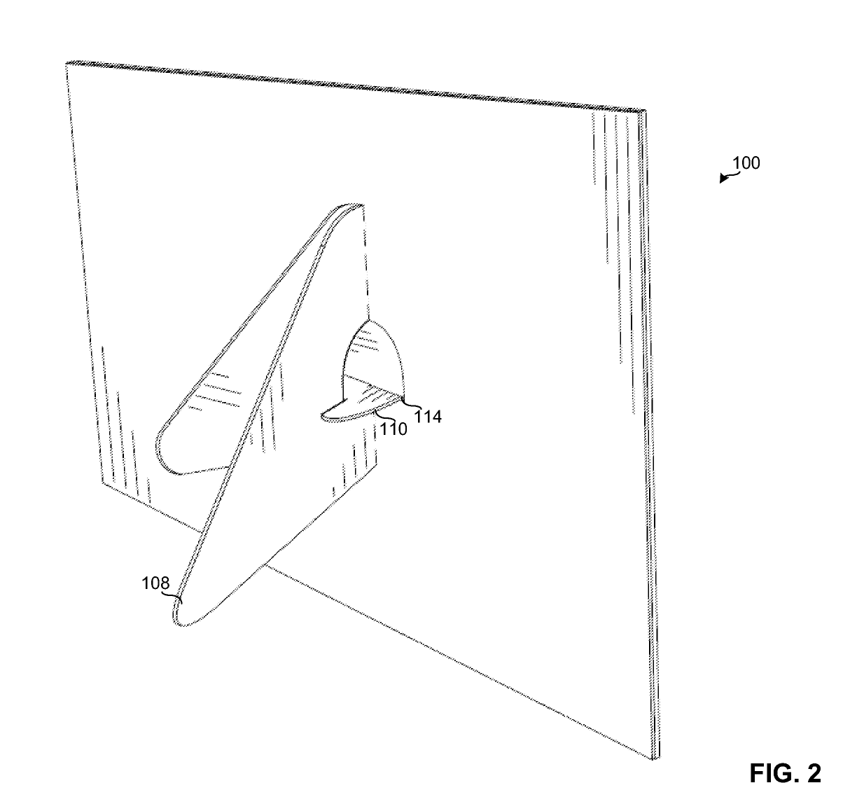

FIG. 2 depicts another view of the example easel 100. In this example, the vertical support 108 is substantially triangularly shaped and the horizontal support 110 is substantially dome shaped; however, the vertical support 108 and/or the horizontal support 110 may be any other shape. For example, the horizontal support 110 may be rectangularly shaped. While one vertical support 108 and one horizontal support 110 are depicted, any number (e.g., 2, 3, 4, etc.) of vertical supports may be used and/or any number (e.g., 2, 3, 4, etc.) of horizontal may be used. If more than one horizontal support and/or vertical support are used, one or more of the supports may be positioned adjacent another one of the supports and/or one or more of the supports may be spaced from another one of the supports, for example.

In some examples, the first layer 102 may be approximately nine point paper weight and the second layer 104 may be between about approximately 60-pound paper weight and approximately nine point paper weight. In some examples, the first layer 102 may be a first thickness and/or substrate and the second layer 104 may be a second thickness and/or substrate different than the first thickness and/or substrate. In other examples, the first thickness may be the same or substantially similar to the second thickness.

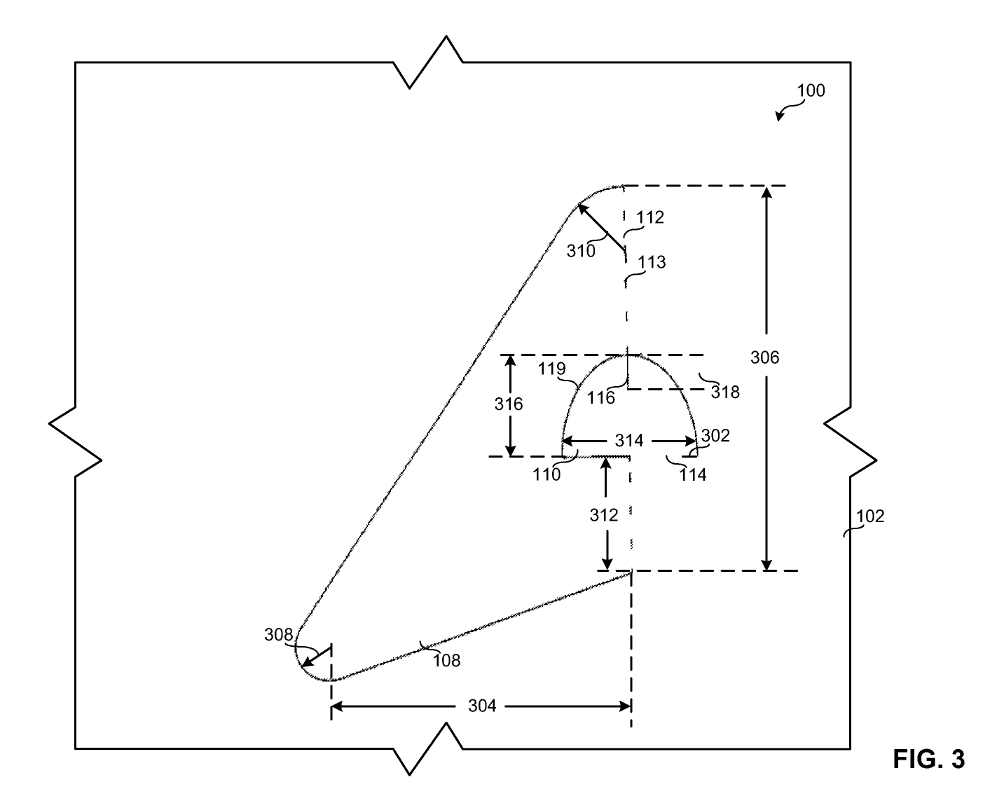

FIG. 3 depicts a plan view of a portion of the first layer 102 of the easel 100 prior to the vertical support 108 and the horizontal support 110 being folded along respective folds 112 and 114 and, thus, prior to being deployed. In practice, the first layer 102 may be cut to define the vertical support 108, the perforation 113, the horizontal support 110, the slit 116 and/or a slit 302. The slit 302 may substantially ensure that the horizontal support 110 is folded along the second fold 114 when the horizontal support 110 is moved in the direction indicated by arrow 122, for example. While one slit 302 is depicted, more than one slit 302 or perforation may be defined along or adjacent to the second fold 114.

In some examples, the vertical support 108, the perforation 113, the horizontal support, the slit 116 and/or the slit 302 are cut during one or more die cutting operations prior to the first layer 102 being coupled to the second layer 104. In some examples, the vertical support 108, the perforation 113, the horizontal support 110, the slit 116 and/or the slit 302 are cut during one or more kiss die cutting operations after the first layer 102 is coupled to the second layer 104. In some examples, the horizontal support 110 includes a portion of the vertical support 108 defining the aperture 119. Thus, in practice, the horizontal support 110 is movable within the aperture 119 at least partially defined by the vertical support 108. In some examples, the aperture 119 or any of the other examples described herein may be different than depicted (e.g., different shape, different size, etc.).

In some examples, a width 304 of the vertical support 108 may be approximately 2.25 inches. In some examples, a height 306 of the vertical support 108 may be approximately 2.875 inches. In some examples, a first radius 308 of the vertical support 108 may be approximately 0.025 inches. In some examples, a second radius 310 of the vertical support 108 may be approximately 0.5 inches.

In some examples, a distance 312 between the vertical support 108 and the horizontal support 110 may be approximately 0.875 inches. In some examples, a width 314 of the horizontal support 110 may be approximately 1.0 inches. In some examples, a height 316 of the horizontal support 110 may be approximately 0.75 inches. In some examples, a length 318 of the slit 116 may be approximately 0.25 inches. However, the examples described herein may be differently sized.

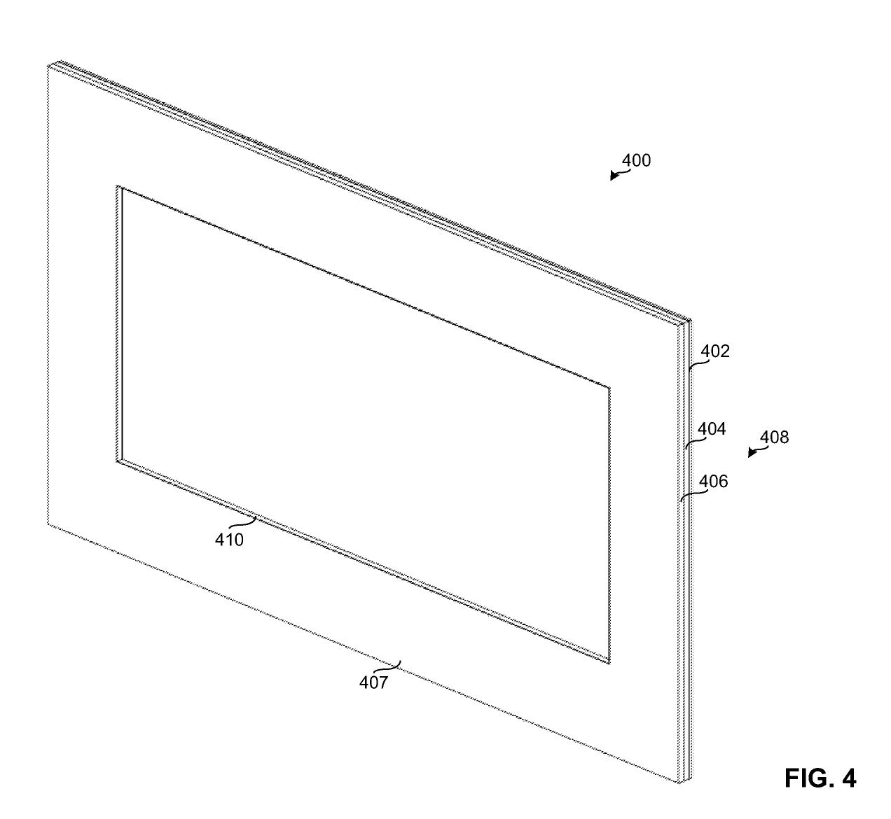

FIG. 4 depicts a front face of an example easel 400 such as an in-line easel or a self standing easel. In contrast to the easel 100 described above, the easel 400 includes a first layer 402, a second layer 404 and a frame component or third layer 406 cut from and/or associated with a frame web roll. In some examples, the first layer 402 may be an easel backer cut from and/or associated with a backer web roll and may be similar to the first layer 102. In some examples, the second layer 404 may be a display component cut from and/or associated with a display web roll and may be similar to the second layer 104. However, if the second layer 404 is different than the second layer 104 of FIGS. 1-3, the second layer 404 may be a layer of material cut from and/or associated with a poly web roll such as and/or including a substantially transparent material, plastic and/or polypropylene, for example. In some examples, the third layer 406 may include one or more additional features. The additional features may include varnish (e.g., UV varnish,), label(s) (e.g., blow on labels), embossing, etc.

The first layer 402 may be coupled to the second layer 404 by pattern or solid pasting. If the second layer 404 is a layer of substantially transparent material, the first layer 402 may be coupled to the second layer 404 around a perimeter 407 of the second layer 404. In such examples, no adhesive or paste may be used at an end or side 408 between the first layer 402 and the second layer 404 to define an opening therebetween. The opening enables an object or document to be inserted into the easel 400. The object or document may be a picture, certificate, advertisement, recognition, award, acknowledgement, etc. Once inserted, the object or document can be viewed through the transparent second layer 404 and through an opening 410 defined by the third layer 406.

The second layer 404 may be coupled to the third layer 406 by pattern or solid pasting. However, in some examples, the second layer 404 may only be coupled to the first layer 402 or the second layer 404. In such examples, the first layer 402 may be coupled to the third layer 406. In some examples, if the second layer 404 is a display component, no adhesive or paste may be used at the end or side 408 between the second layer 404 and the third layer 406 to define an opening therebetween and to enable an object to be inserted into the easel 400. Thus, the versatility of the easel 400 is increased by enabling either the information included on the second layer 404 to be displayed through the transparent second layer 404 and the opening 410 or the inserted object or document to be displayed through the transparent second layer 404 and the opening 410.

While not shown, the first layer 402 may include a support structure similar to the support structure 106 of FIG. 1. Additionally or alternatively, the first layer 402 may define an opening or aperture to enable the easel 400 to be hung and/or suspended.

The first, second and/or third layers 402-406 may be made of similar or different materials and/or substrates. The materials may include paper, plastic, etc. In some examples, the first layer 402 may be approximately nine point paper weight. In some examples, the second layer 404 may be between about approximately 60-pound paper weight and approximately nine point paper weight. In other examples, the second layer 404 may be polypropylene or any other substantially transparent material. The first layer 402 may be a similar or different thickness than either the second and/or third layers 404 and 406. The second layer 404 may be a similar or different thickness than the first and/or third layers 402 and 406. The third layer 406 may be a similar or different thickness than the first and/or second layers 402 and 404.

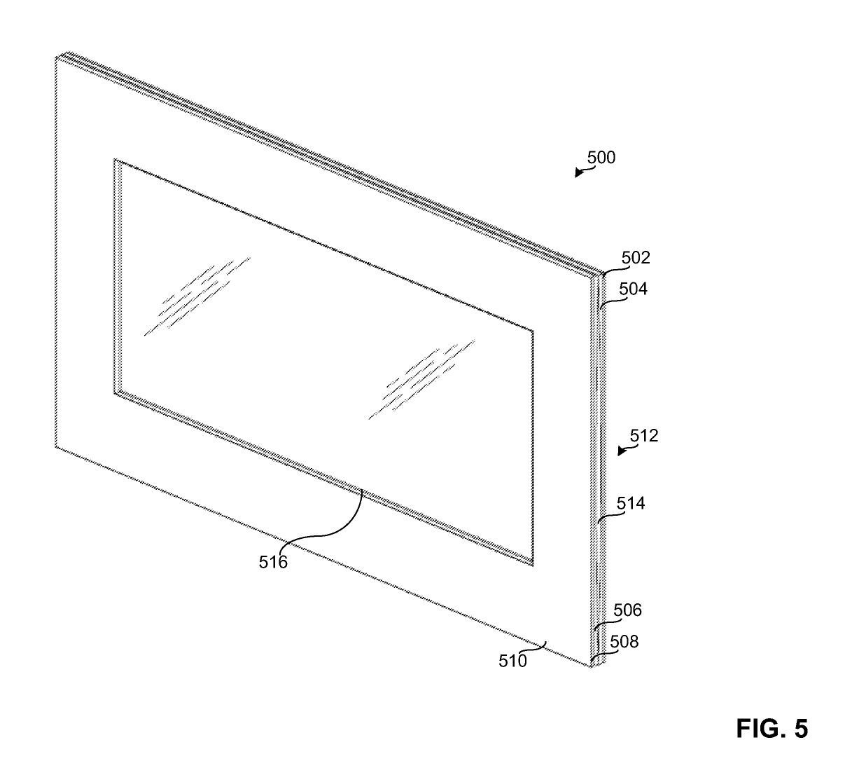

FIG. 5 depicts an example an easel 500 such as an in-line easel or a self standing easel. The easel 500 includes a first layer 502, a second layer 504, a third layer 506 and a fourth layer 508. In some examples, the layers 502, 504, 506 and/or 508 may be of similar or different thicknesses. In some examples, the layers 502, 504, 506 and/or 508 may be made of one or more similar or different materials and/or substrates.

The first layer 502 may be an easel backer cut from and/or associated with a backer web roll and may be similar to the first layer 102 of FIGS. 1-3. The second layer 504 may be a display component cut from and/or associated with a display web roll and may be similar to the second layer 104 of FIGS. 1-3. The third layer 506 may be a polypropylene cover or any other transparent material cut from and/or associated with a poly web roll, for example. In some examples, the third layer 506 may be a label layer such as, for example, a ribbon layer associated with a certification. The fourth layer 508 may be a frame component cut from and/or associated with a frame web roll and may be similar to the third layer 406 of FIG. 4. In some examples, the second and/or fourth layers 504 and/or 508 or any of the other layers may include one or more additional features. The additional features may include varnish (e.g., UV varnish), label(s) (e.g., blow on labels), embossing, etc.

The first layer 502 may be coupled to the second layer 504 by solid or pattern pasting a front face of the first layer 502 and coupling a back face of the second layer 504 thereto, for example. A perimeter 510 of the second layer 504 may be coupled to the third layer 506 by solid or pattern pasting a front face of the second layer 504 and coupling a back face of the third layer 506 thereto, for example. In some examples, at an end or side 512 of the easel 500, a portion of the second layer 504 may not be coupled to a portion of the third layer 506 to define an opening 514 therebetween. The opening 514 enables an object or document to be inserted into the easel 400. Once inserted, the object or document can be viewed through the transparent third layer and through an opening or window 516 defined by the fourth layer 508. The third layer 506 may be coupled to the fourth layer 508 by solid or pattern pasting a front face of the third layer 506 and coupling a back face of the fourth layer 508 thereto, for example.

While not shown, the first layer 502 may include a support structure similar to the support structure 106 of FIG. 1 and/or any other structure to enable the easel 500 to be displayed and/or hung and/or suspended.

The first, second, third and/or fourth layers 502-508 may be made of similar or different materials and/or substrates. The materials may include paper, plastic, etc. In some examples, the first layer 502 may be approximately nine point paper weight. In some examples, the second layer 504 may be between about approximately 60-pound paper weight and approximately nine point paper weight. In other examples, the third layer 506 may be polypropylene or any other substantially transparent material. The first layer 502 may be a similar or different thickness than any of the second, third and/or fourth layers 504-508. The second layer 504 may be a similar or different thickness than any of the first, third and/or fourth layers 502, 506 and 508. The third layer 506 may be a similar or different thickness than any of the first, second and/or fourth layers 502, 504 and 508. The fourth layer 508 may be a similar or a different thickness than any of the first, second and/or third layers 502-506.

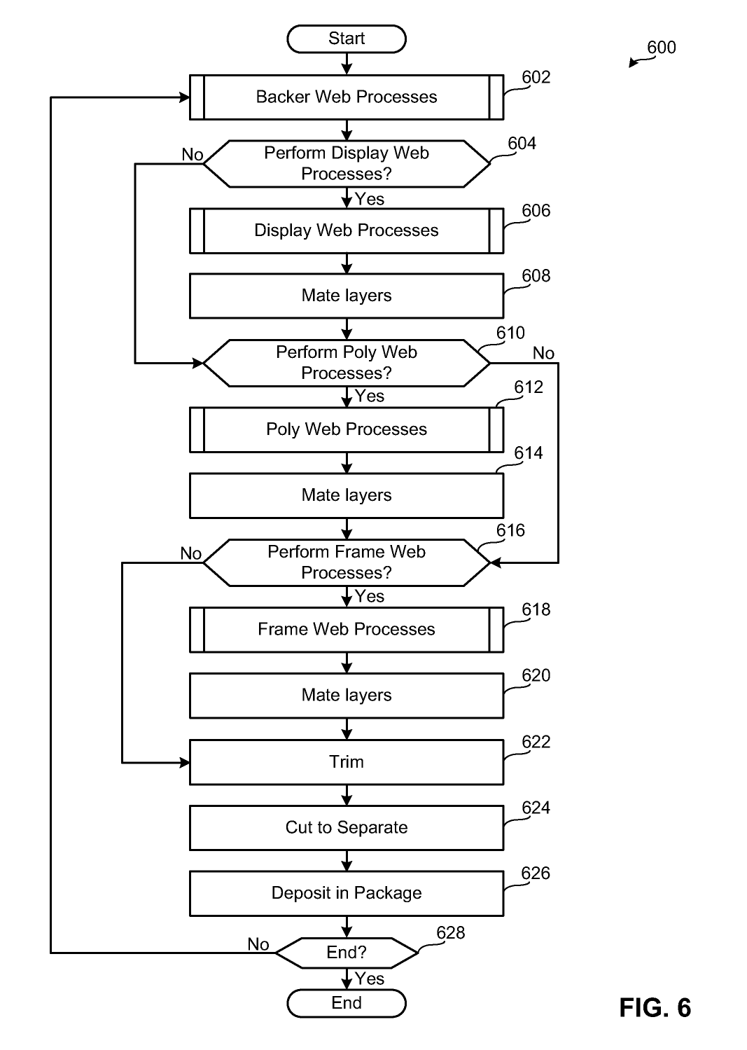

FIGS. 6-14 depict example flow diagrams representative of processes that may be implemented using, for example, computer readable instructions that may be carried out in conjunction with paper processing equipment such as die cutters, web presses, etc. to produce the example easel(s) 100, 400 and/or 500 or any other of the examples described herein. The example processes of FIGS. 6-14 may be performed using a processor, a controller and/or any other suitable processing device. For example, the example processes of FIGS. 6-14 may be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example processes of FIGS. 6-14 may be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example processes of FIGS. 6-14 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIGS. 6-14 may be implemented manually or as any combination(s) of any of the foregoing techniques, for example, any combination of firmware, software, discrete logic and/or hardware. Further, although the example processes of FIGS. 6-14 are described with reference to the flow diagrams of FIGS. 6-14, other methods of implementing the processes of FIGS. 6-14 may be employed. For example, the order of execution of the blocks may be changed, and/or some of the blocks described may be changed, eliminated, sub-divided, or combined. Additionally, any or all of the example processes of FIGS. 6-14 may be performed sequentially and/or in parallel by, for example, separate processing threads, processors, devices, discrete logic, circuits, etc.

FIG. 6 represents an example method 600 of producing the examples described herein. While the processes of the method 600 are depicted as being performed sequentially, one or more of the processes may be performed in parallel, for example.

At 602, the method 600 performs the Backer Web Processes. The Backer Web Processes are associated with a backer web roll or first layer and will be discussed in more detail below. Some of the Backer Web Processes may include defining a support structure, etc. in the first layer.

At 604, the method 600 determines whether or not to perform the Display Web Processes. The Display Web Processes are associated with a display web roll or second layer and will be discussed in more detail below. The Display Web Processes may be performed in connection with producing an easel having two layers, three layers and/or four layers, for example. Some of the Display Web Processes may include printing and/or imaging the second layer. If the method 600 determines to perform the Display Web Processes, control advances to block 606 and the Display Web Processes are then performed. At 608, the layers are mated. For example, the first layer may be mated and/or coupled to the second layer. However, if the method 600 determines not to perform the Display Web Processes, control advances to 610.

At 610, the method 600 determines whether or not to perform the Poly Web Processes. The Poly Web Processes are associated with a poly or third layer and will be discussed in more detail below. The Poly Web Processes may be performed in connection with producing an easel having three layers and/or four layers, for example. Some of the Poly Web Processes may include printing the third layer. If the method 600 determines to perform the Poly Web Processes, control advances to block 612 and the Poly Web Processes are then performed. At 614, the layers are mated. In some examples, at 614, the first and second layers are mated and/or coupled with the third layer. In some examples, at 614, the first layer is mated and/or coupled with the third layer. However, if the method 600 determines not to perform the Poly Web Processes, control advances to 616.

At 616, the method 600 determines whether or not to perform the Frame Web Processes. The Frame Web Processes are associated with a frame web roll or fourth layer and will be discussed in more detail below. The Frame Web Processes may be performed in connection with producing an easel having two layers, three layers and/or four layers, for example. Some of the Frame Web Processes may include printing and/or imaging the fourth layer. If the method 600 determines to perform the Frame Web Processes, control advances to block 618 and the Frame Web Processes are then performed. At 620, the layers are mated. In some examples, at 620, the first and fourth layers are mated and/or coupled to produce an easel having two layers. In such examples, an opening may be defined between the first and fourth layers to enable an object to be inserted therein. In some examples, at 620, the first and second layers are mated and/or coupled with the fourth layer to produce an easel having three layers. In some examples, at 620, the first, second and third layers are mated and/or coupled with the fourth layer to produce an easel having four layers. However, if the method 600 determines not to perform the Frame Web Processes, control advances to 622.

At 622, the mated layers are trimmed. In some examples, trimming includes trimming the width of the mated layers to be a uniform width. If the easel includes two layers, trimming includes trimming the width of the two layers. If the easel includes three layers, trimming includes trimming the width of three layers. If the easel includes four layers, trimming includes trimming the width of four layers. While easels having two, three and four layers each associated with different web rolls are described, easels may be produced having any other number of layers instead. For example, easels having five layers, six layers, seven layers, etc. may be produced. In some examples, a plurality (e.g., 2, 3, 4, etc.) of frame layers having similar or different shape(s) and/or size(s) may be included in the easel produced. The different frame layers may be associated with different web rolls. In some examples, one or more of the layers may be a label layer.

At 624, the mated layers (e.g., mated webs) are cut to separate the easels from one another. At 626, one or more of the separated easels are deposited in a package. The package may include the easel and one or more other documents to be mailed to a recipient, for example. At 628, the method 600 determines whether or not to advance to block 602. Otherwise, the example method 600 is ended.

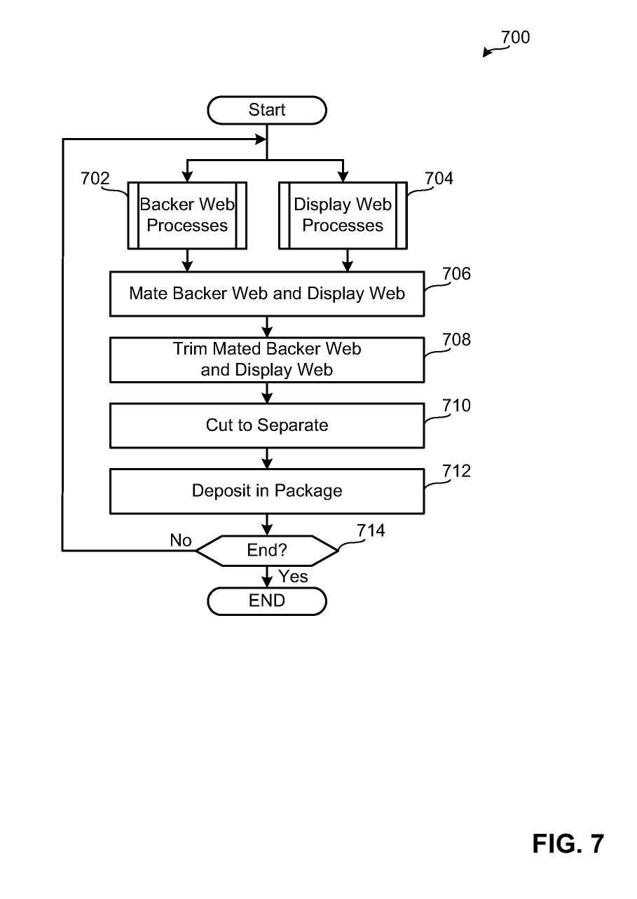

FIG. 7 represents an example method 700 of producing an example easel similar to the example easel 100. At 702 and 704, respectively, the Backer Web Processes and the Display Web Processes are performed. The Backer Web Processes and the Display Web Processes are discussed in more detail below. While the Backer Web Processes and the Display Web Processes are depicted as being performed in parallel, portions or all of the Backer Web Processes and Display Web Processes may be performed sequentially, for example. The Backer Web Processes are associated with a backer web roll or first layer and the Display Web Processes are associated with a display web roll or second layer.

At 706, the backer web and the display web are mated. Mating the backer web and the display web couple the webs together (e.g., couple a front face of the backer web to a back face of the display web). At 708, the mated backer web and display web are trimmed In some examples, the width of the mated backer web and display web are trimmed to be a uniform width. At 710, the mated backer web and display web are cut to separate the easels from one another. At 712, one or more of the separated easels are deposited in a package. The package may include the easel and one or more other documents to be mailed to a recipient, for example. At 714, the method 700 determines whether or not to end. Otherwise, the example method 700 is ended.

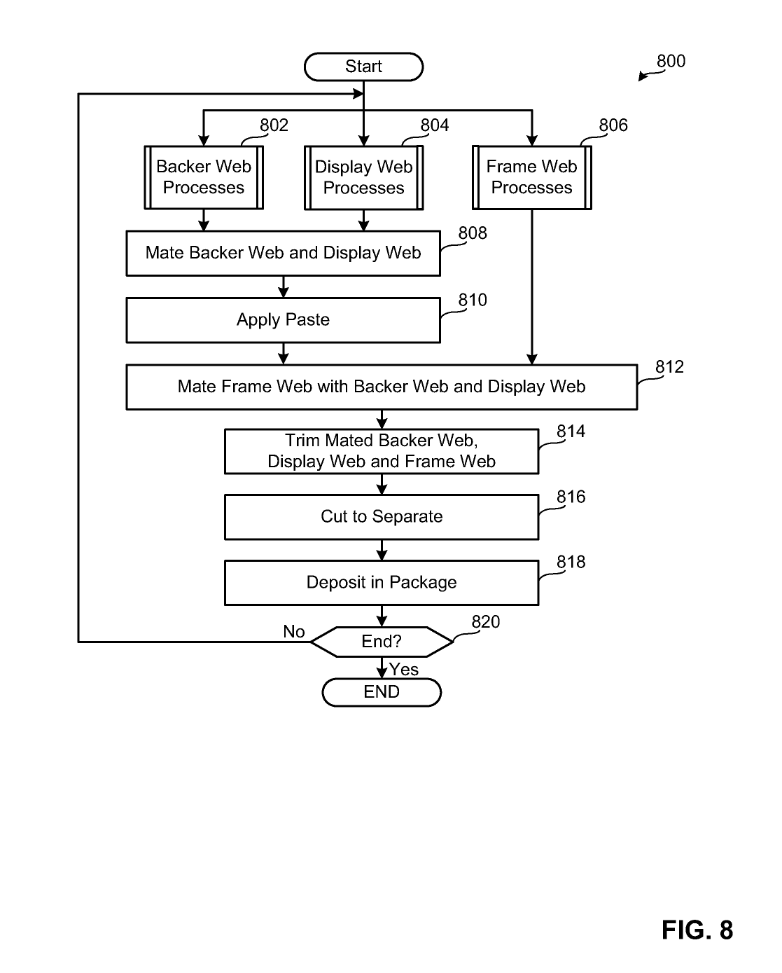

FIG. 8 represents an example method 800 of producing an example easel similar to the example easel 400. At 802, 804 and 806, respectively, the Backer Web Processes, the Display Web Processes and the Frame Web Processes are performed. The Backer Web Processes, the Display Web Processes and the Frame Web Processes are discussed in more detail below. While the Backer Web Processes, the Display Web Processes and the Frame Web Processes are depicted as being performed in parallel, portions or all of the Backer Web Processes, the Display Web Processes and/or the Frame Web Processes may be performed sequentially, for example. The Backer Web Processes are associated with a backer web roll or first layer, the Display Web Processes are associated with a display web roll or second layer and the Frame Web Processes are associated with a frame web roll or third layer.

At 808, the backer web and the display web are mated. Mating the backer web and the display web couple the webs together (e.g., couple a front face of the backer web and a back face of the display web). At 810, paste and/or adhesive is applied to the mated backer web and display web. The paste may be applied by solid or pattern pasting a front face of the display web, for example. At 812, the frame web is mated with the backer web and the display web (e.g., couple a front face of the display web and a back face of the frame web). The display web may be positioned between the frame web and the backer web. At 814, the mated backer web, display web and frame web are trimmed In some examples, the width of the mated backer web, display web and frame web are trimmed to be a uniform width. At 816, the mated backer web, display web and frame web are cut to separate the easels from one another. At 818, one or more of the separated easels are deposited in a package. The package may include the easel and one or more other documents to be mailed to a recipient, for example. At 820, the method 800 determines whether or not to end. Otherwise, the example method 800 is ended.

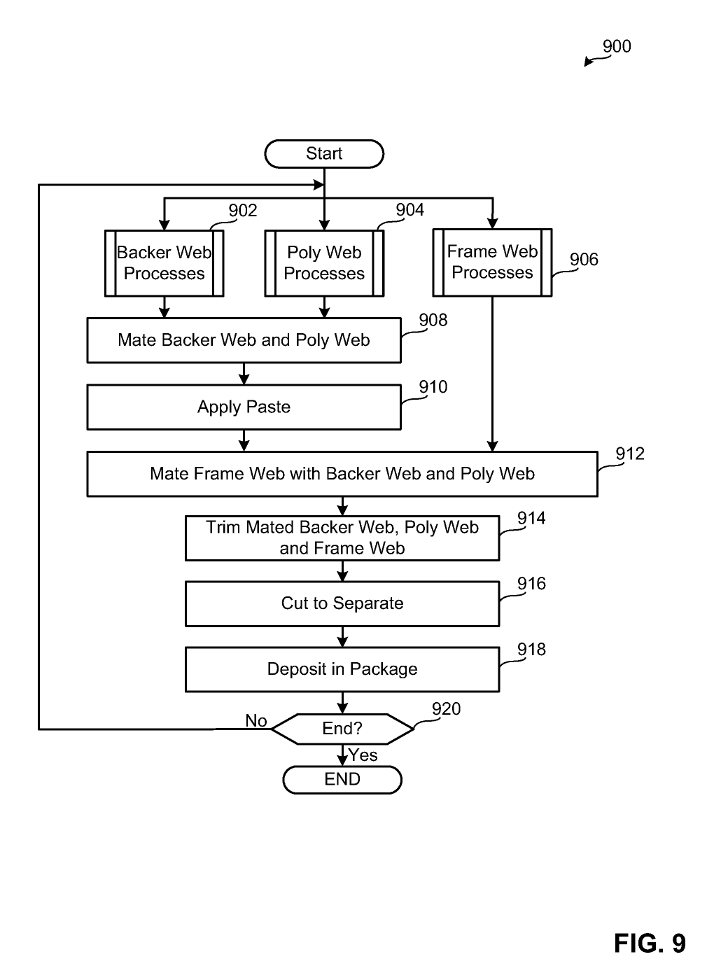

FIG. 9 represents an example method 900 of producing an example easel similar to the example easel 400. At 902, 904 and 906, respectively, the Backer Web Processes, the Poly Web Processes and the Frame Web Processes are performed. The Backer Web Processes, the Poly Web Processes and the Frame Web Processes are discussed in more detail below. While the Backer Web Processes, the Poly Web Processes and the Frame Web Processes are depicted as being performed in parallel, portions or all of the Backer Web Processes, the Poly Web Processes and/or the Frame Web Processes may be performed sequentially, for example. The Backer Web Processes are associated with a backer web roll or first layer, the Poly Web Processes are associated with a poly web roll (e.g., polypropylene web) or second layer and the Frame Web Processes are associated with the frame web roll or third layer. In some examples, in connection with the Backer Web Processes, paste is applied to three sides of the portion of the backer web to be the exterior or perimeter surface of the easel. Applying paste to the three sides enables an opening to be defined once the backer web and the poly web are mated at 908.

At 908, the backer web and the poly web are mated. Mating the backer web and the poly web couple the webs together (e.g., couple a front face of the backer web and a back face of the poly web). In some examples, an opening may be defined at an end or side between the backer web and the poly web to enable an object or document to be inserted therein.

At 910, paste and/or adhesive is applied to the mated backer web and the poly web. The paste may be applied by solid or pattern pasting a front face of the poly web. At 912, the frame web is mated with the backer web and the poly web. Mating the frame web with the backer web and the poly web couple the webs together (e.g., couple a front face of the poly web and a back face of the frame web). The poly web may be positioned between the frame web and the backer web. At 914, the mated backer web, poly web and frame web are trimmed In some examples, the width of the mated backer web, poly web and frame web are trimmed to be a uniform width. At 916, the mated backer web, poly web and frame web are cut to separate the easels from one another. At 918, one or more of the separated easels are deposited in a package. The package may include the easel and one or more other documents to be mailed to a recipient, for example. At 920, the method 900 determines whether or not to end. Otherwise, the example method 900 is ended.

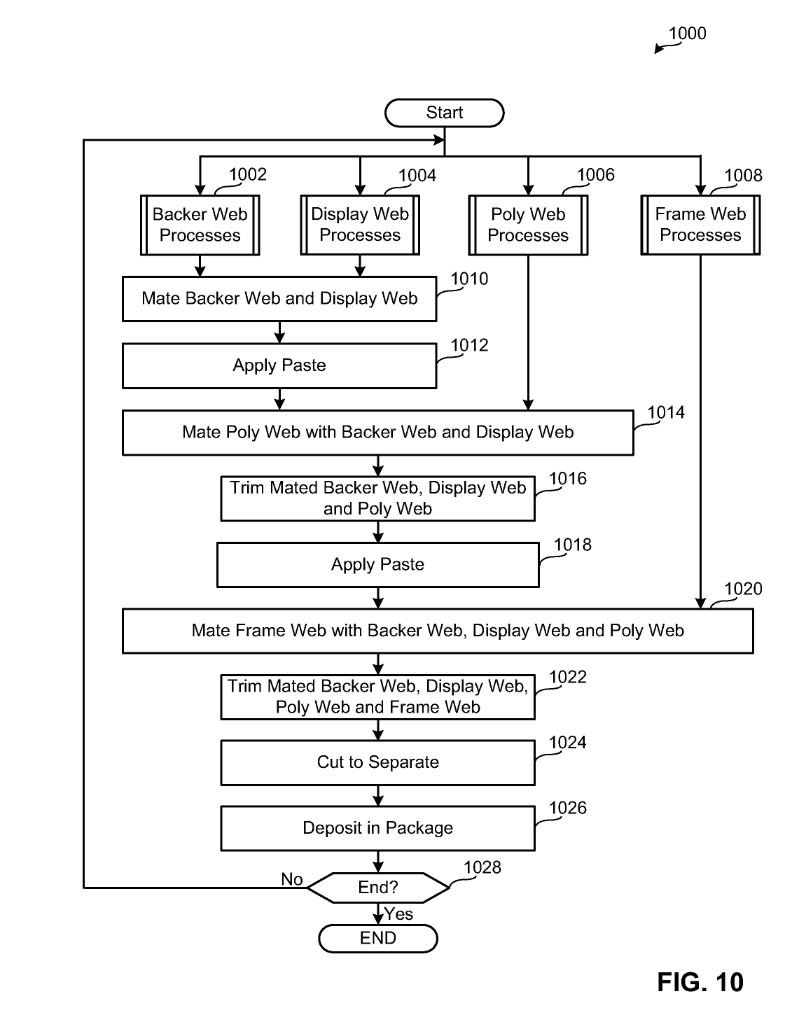

FIG. 10 represents an example method 1000 of producing an example easel similar to the example easel 500. At 1002, 1004, 1006 and 1008, respectively, the Backer Web Processes, the Display Web Processes, the Poly Web Processes and the Frame Web Processes are performed. The Backer Web Processes, the Display Web Processes, the Poly Web Processes and the Frame Web Processes are discussed in more detail below. While the Backer Web Processes, the Display Web Processes, the Poly Web Processes and the Frame Web Processes are depicted as being performed in parallel, portions or all of the Backer Web Processes, the Display Web Processes, the Poly Web Processes and/or the Frame Web Processes may be performed sequentially, for example. The Backer Web Processes are associated with a backer web roll or first layer, the Display Web Processes are associated with a display web roll or second layer, the Poly Web Processes are associated with a poly web roll (e.g., polypropylene web) or third layer and the Frame Web Processes are associated with a frame web roll or fourth layer.

At 1010, the backer web and the display web are mated. Mating the backer web and the display web couple the webs together (e.g., couple a front face of the backer web and a back face of the display web). At 1012, paste and/or adhesive is applied to the mated backer web and the display web. The paste may be applied by solid or pattern pasting a front face of the display web, for example. In some examples, to enable an opening to be defined between the display web and the poly web once mated at 1014, paste may be applied to three sides of the portion of the display web to be the exterior or perimeter surface of the easel.

At 1014, the poly web is mated with the backer web and the display web. Mating the poly web and the backer web and the display web couple the webs together (e.g., couple a front face of the display web and a back face of the poly web). The display web may be positioned between the poly web and the backer web. At 1016, the mated backer web, display web and poly web are trimmed. In some examples, the width of the mated backer web, display web and poly web are trimmed to be a uniform width. At 1018, paste and/or adhesive is applied to the mated backer web, display web and poly web. The paste may be applied by solid or pattern pasting a front face of the poly web, for example.

At 1020, the frame web is mated with the backer web, the display web and the poly web. Mating the frame web with the backer web, the display web and the poly web couple the webs together (e.g., couple a front face of the poly web and a back face of the frame web).

At 1022, the mated backer web, display web, poly web and frame web are trimmed In some examples, the width of mated backer web, display web, poly web and frame web are trimmed to be a uniform width. At 1024, the mated backer web, display web, poly web and frame web are cut to separate the easels from one another. At 1026, one or more of the separated easels are deposited in a package. The package may include the easel and one or more other documents to be mailed to a recipient, for example. At 1028, the method 1000 determines whether or not to end. Otherwise, the example method 1000 is ended.

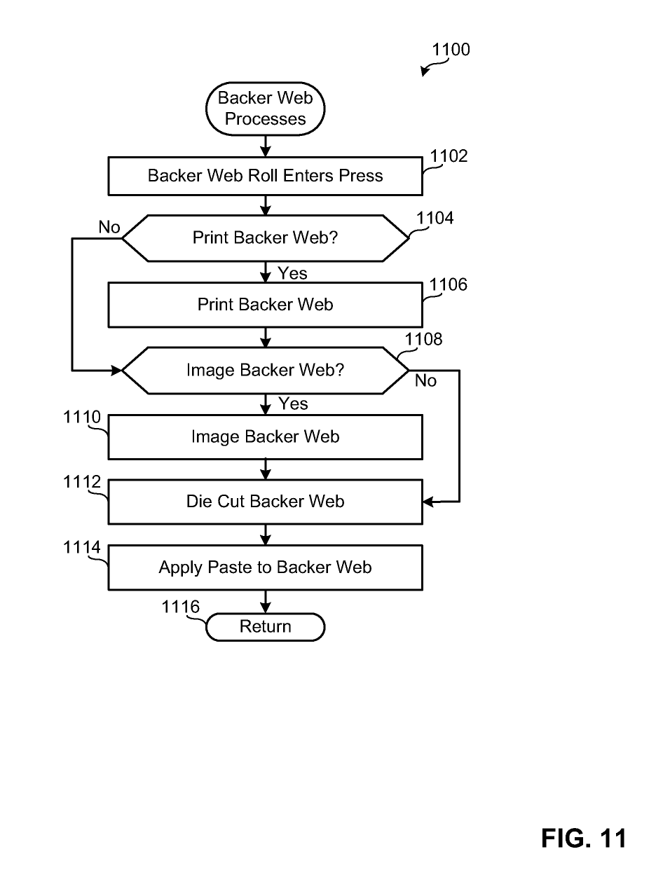

FIG. 11 depicts an example method 1100 representing the Backer Web Processes. The Backer Web Processes are associated with the easel backer or first layer of any of the examples described herein. At 1102, an easel backer web roll enters a press. At 1104, the method 1100 determines whether or not to print the backer web. Printing the backer web may include using one or more plates to print standard, non-customized or non-personalized information on the backer web. Standard information may include the name of an organization, images associated with an organization, a calendar, etc. If the method 1100 determines to print the backer web, control advances to block 1106 and the backer web is printed. Printing the backer web may occur during one or more processes. However, if the method 1100 determines not to print the backer web, control advances to block 1108.

At 1108, the method 1100 determines whether or not to image the backer web. Imaging the backer web may include using one or more print heads to print non-standard, customized or personalized information on the backer web. Customized information may include a recipient's name, the number of years that a recipient has been a member of or contributed to an organization, an amount that a recipient has donated to an organization, etc. If the method 1100 determines to image the backer web, control advances to block 1110 and the backer web is imaged. Imaging the backer web may occur during one or more processes. However, if the method 1100 determines not to image the backer web, control advances to block 1112.

At 1112, the backer web is die cut. In some examples, the backer web is die cut to define a vertical support, a perforation, a horizontal support, one or more slits, etc. At 1114, the method 1100 applies paste and/or adhesive to the backer web. The paste may be applied by pattern or solid pasting a front face of the backer web, for example. In some examples, the paste is applied to a portion of the backer web to be the exterior or perimeter surface of the easel. In some example, the paste is applied to three sides of the portion of the backer web to be the exterior or perimeter surface of the easel. If paste is only applied to three sides of the backer web, the easel produced will define an opening to enable an object to be inserted therein. At 1116, control returns one of the methods 600, 700, 800, 900 and/or 1000.

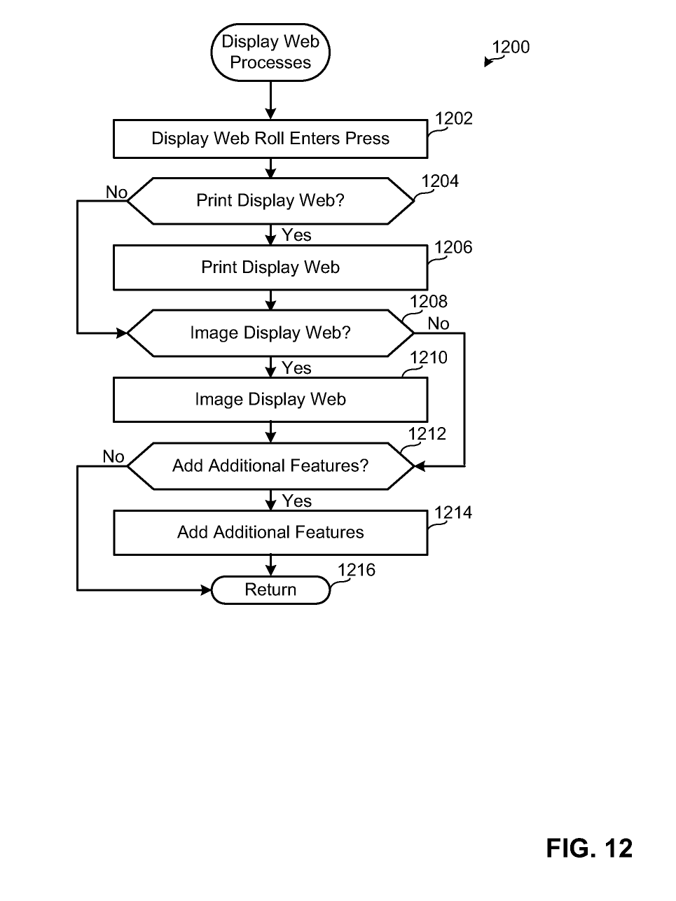

FIG. 12 depicts an example method 1200 representing the Display Web Processes. The Display Web Processes are associated with the easel display or second layer of any of the examples described herein. At 1202, a display web roll enters a press. At 1204, the method 1200 determines whether or not to print the display web. If the method 1200 determines to print the display web, control advances to block 1206 and the display web is printed. Printing the display web may occur during one or more processes. However, if the method 1200 determines not to print the display web, control advances to block 1208.

At 1208, the method 1200 determines whether or not to image the display web. If the method 1200 determines to image the display web, control advances to block 1210 and the display web is imaged. Imaging the display web may occur during one or more processes. However, if the method 1200 determines not to image the display web, control advances to block 1212.

At 1212, the method 1200 determines whether or not to add one or more additional features to the display web. The additional features may include varnish (e.g., UV varnish), label(s) (e.g., blow on labels), embossing, etc. If the method 1200 determines to add one or more additional features, control advances to block 1214 and the one or more additional features are added. The additional features may be added during one or more processes. However, if the method 1200 determines not to add the one or more additional features, control advances to block 1216. At 1216, control returns one of the methods 600, 700, 800, 900 and/or 1000.

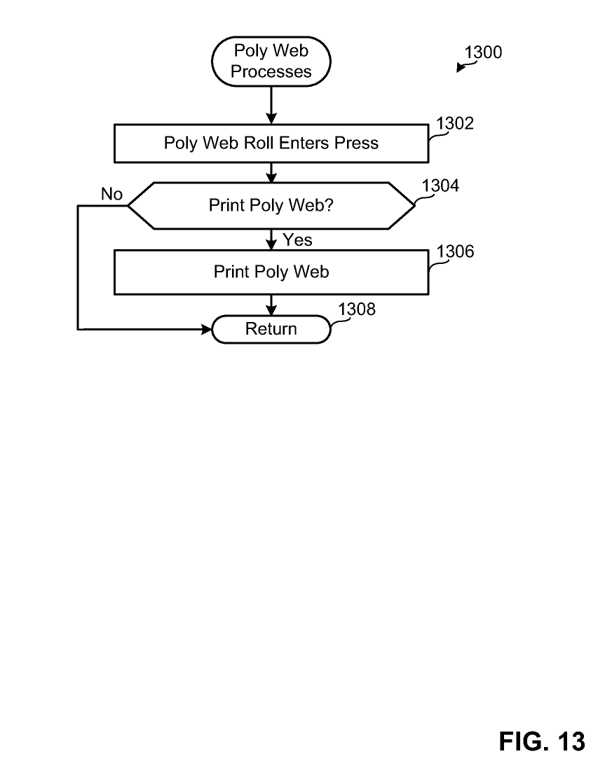

FIG. 13 depicts an example method 1300 representing the Poly Web Processes. The Poly Web Processes are associated with the poly or third layer (e.g., a substantially transparent material) of any of the examples described herein. At 1302, a poly web roll enters a press. At 1304, the method 1300 determines whether or not to print the poly web. If the method 1300 determines to print the poly web, control advances to block 1306 and the poly web is printed. Printing the poly web may occur during one or more processes. However, if the method 1300 determines not to print the poly web, control advances to block 1308. At 1308, control returns one of the methods 600, 700, 800, 900 and/or 1000.

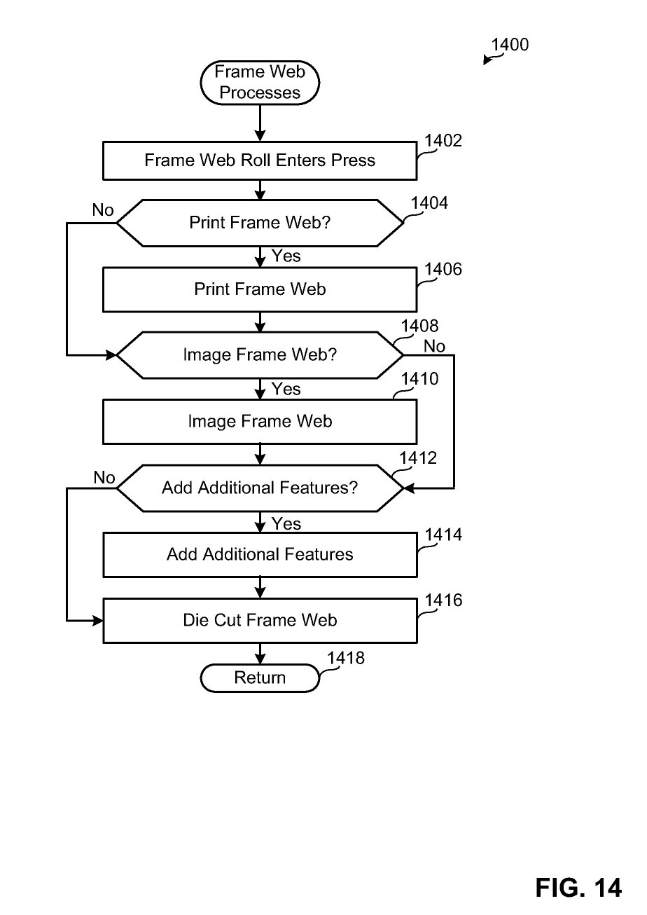

FIG. 14 depicts an example method 1400 representing the Frame Web Processes. The Frame Web Processes are associated with the easel frame or fourth layer of any of the examples described herein. At 1402, a frame web roll enters a press. At 1404, the method 1400 determines whether or not to print the frame web. If the method 1400 determines to print the frame web, control advances to block 1406 and the frame web is printed. Printing the frame web may occur during one or more processes. However, if the method 1400 determines not to print the frame web, control advances to block 1408.

At 1408, the method 1400 determines whether or not to image the frame web. If the method 1400 determines to image the frame web, control advances to block 1410 and the frame web is imaged. Imaging the frame web may occur during one or more processes. However, if the method 1400 determines not to image the frame web, control advances to block 1412.

At 1412, the method 1400 determines whether or not to add one or more additional features to the frame web. The additional features may include varnish (e.g., UV varnish), label(s) (e.g., blow on labels), embossing, etc. If the method 1400 determines to add one or more additional features, control advances to block 1414 and the one or more additional features are added. The additional features may be added during one or more processes. However, if the method 1400 determines not to add one or more additional features, control advances to block 1416. At 1416, the frame web is die cut to define an opening therethrough, for example. At 1418, control returns one of the methods 600, 700, 800, 900 and/or 1000.

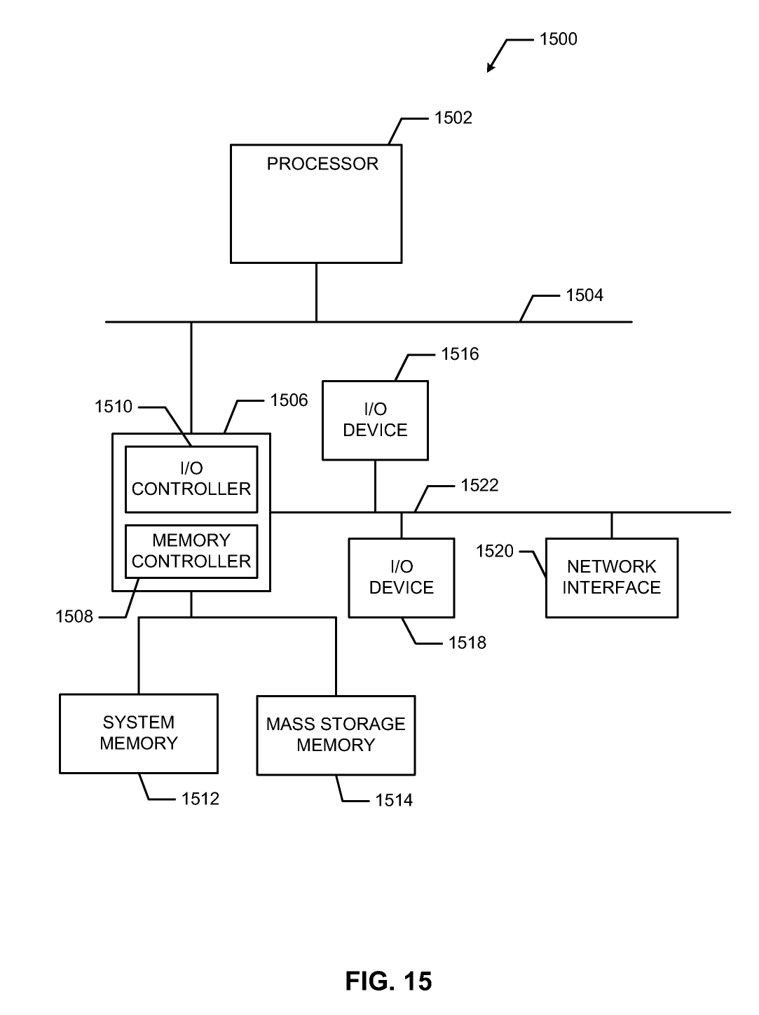

FIG. 15 is a block diagram of an example processor system 1500 that may be used to implement the methods described herein. As shown in FIG. 15, the processor system 1500 includes a processor 1502 that is coupled to an interconnection bus 1504. The processor 1502 may be any suitable processor, processing unit or microprocessor. Although not shown in FIG. 15, the processor system 1500 may be a multi-processor system and, thus, may include one or more additional processors that are identical or similar to the processor 1502 and that are communicatively coupled to the interconnection bus 1504.

The processor 1502 of FIG. 15 is coupled to a chipset 1506, which includes a memory controller 1508 and an input/output (I/O) controller 1510. As is well known, a chipset typically provides I/O and memory management functions as well as a plurality of general purpose and/or special purpose registers, timers, etc. that are accessible or used by one or more processors coupled to the chipset 1506. The memory controller 1508 performs functions that enable the processor 1502 (or processors if there are multiple processors) to access a system memory 1512 and a mass storage memory 1514.

The system memory 1512 may include any desired type of volatile and/or non-volatile memory such as, for example, static random access memory (SRAM), dynamic random access memory (DRAM), flash memory, read-only memory (ROM), etc. The mass storage memory 1514 may include any desired type of mass storage device including hard disk drives, optical drives, tape storage devices, etc.

The I/O controller 1510 performs functions that enable the processor 1502 to communicate with peripheral input/output (I/O) devices 1516 and 1518 and a network interface 1520 via an I/O bus 1522. The I/O devices 1516 and 1518 may be any desired type of I/O device such as, for example, a keyboard, a video display or monitor, a mouse, etc. The network interface 1520 may be, for example, an Ethernet device, an asynchronous transfer mode (ATM) device, an 802.11 device, a DSL modem, a cable modem, a cellular modem, etc. that enables the processor system 1500 to communicate with another processor system.

While the memory controller 1508 and the I/O controller 1510 are depicted in FIG. 15 as separate blocks within the chipset 1506, the functions performed by these blocks may be integrated within a single semiconductor circuit or may be implemented using two or more separate integrated circuits.

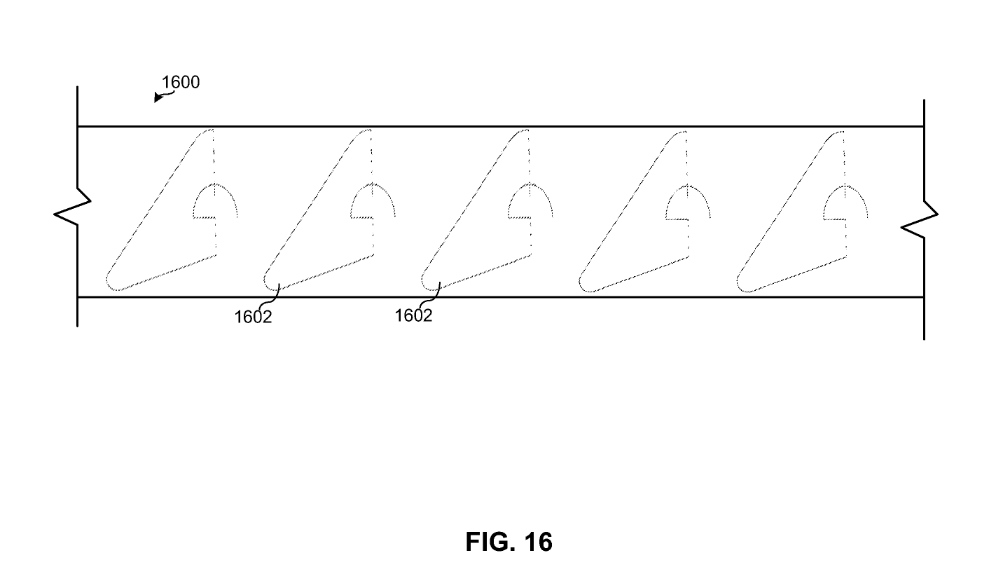

FIG. 16 depicts a backer web 1600 having a plurality of support structures 1602. In some examples, the backer web 1600 depicted in FIG. 16 may be coupled to another web such as a display web, a frame web, a poly web etc. In some examples, the backer web 1600 depicted in FIG. 16 may have been die cut to define the support structures 1602 but has not yet been coupled to another web. In either case, the backer web 1600 has not yet been cut to separate the easels from one another.

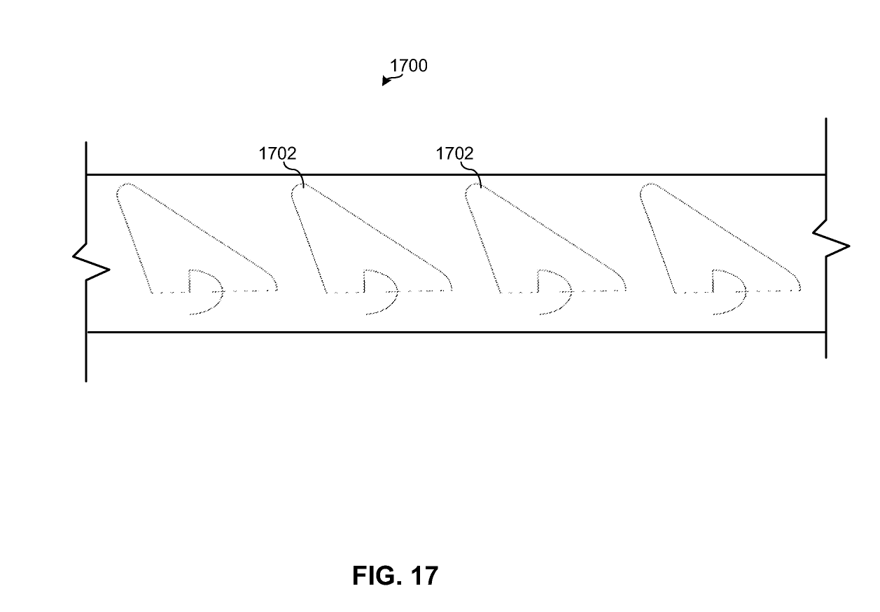

FIG. 17 depicts a backer web 1700 having a plurality of support structures 1702 in a different orientation than the support structures 1602 of FIG. 16. While two different orientations of the support structures are depicted in FIGS. 16 and 17, the support structures may be in any other suitable orientation. In some examples, the backer web 1700 depicted in FIG. 17 may be coupled to another web such as a display web, a frame web, a poly web etc. In some examples, the backer web 1700 depicted in FIG. 17 may have been die cut to define the support structures 1702 but has not yet been coupled to another web. In either case, the backer web 1700 has not yet been cut to separate the easels from one another.

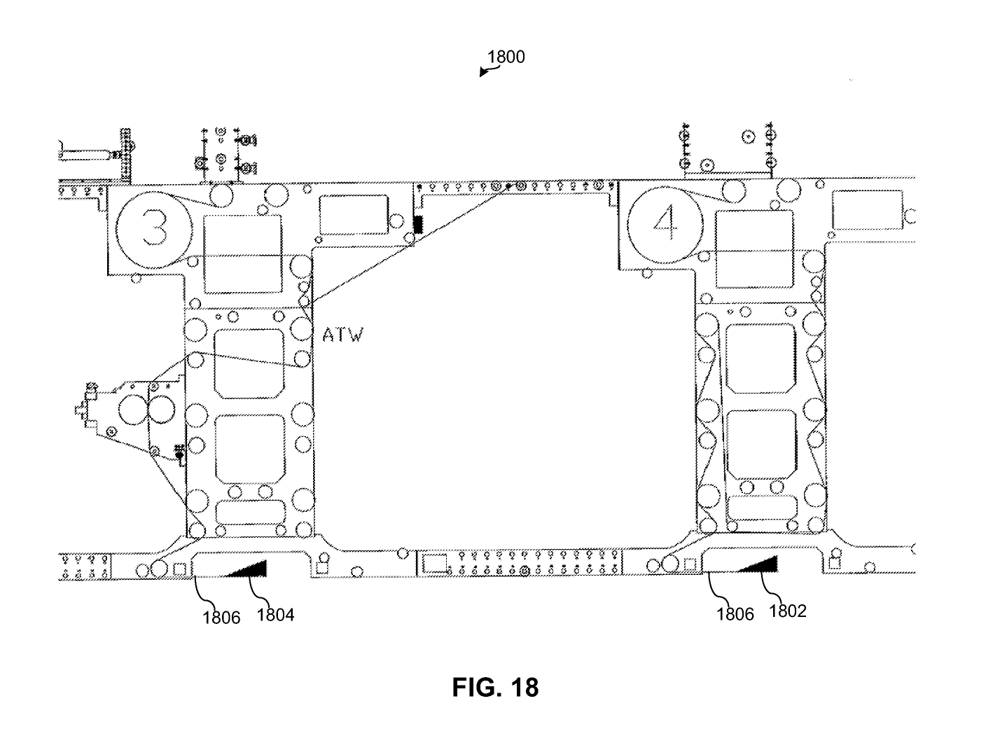

FIG. 18 depicts a portion of an example process 1800 that may be used to produce the examples described herein. The example process includes a first web roll 1802 and a second web roll 1804. The first web 1806 of the first web roll 1802 is to proceed past a plurality of rollers and/or processes prior to being mated with a second web 1808 of the second web roll 1804. The second web 1808 of the second web roll 1804 is to proceed past a plurality of rollers and/or processes prior to being mated with the first web 1806.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. An easel, comprising:
a backer layer associated with a first web roll, the backer layer comprising a planar portion and a support structure, and
a display layer associated with a second web roll different from the first web roll, the display layer comprising a front face and a back face, the back face coupled to the backer layer, wherein the front face includes information associated with a recipient of the easel or an organization.

2. The easel of claim 1, further comprising a frame layer defining an opening, wherein the frame layer is coupled to the display layer and the opening enables the information to be displayed therethrough.

3. The easel of claim 1, further comprising an opening at a side of the easel between the display layer and a frame layer coupled thereto to enable an object to be inserted therebetween.

4. The easel of claim 1, further comprising a substantially transparent layer coupled to at least one of the display layer or a frame layer to enable the information to be displayed therethrough.

5. The easel of claim 1, wherein the back face of the display layer is coupled to the backer layer via adhesive.

6. The easel of claim 1, wherein the support structure comprises a vertical support hingably coupled to the planar portion via a first fold.

7. The easel of claim 6, further comprising a horizontal support hingably coupled to the planar portion via a second fold, the horizontal support interacts with the vertical support to secure the vertical support relative to the easel.

8. The easel of claim 7, wherein the horizontal support interacts with the vertical support via a slit defined by the horizontal support that receives a portion of the vertical support.

9. The easel of claim 7, wherein the second fold defines one or more slits to facilitate folding.

10. The easel of claim 7, wherein the first fold includes one or more perforations to facilitate folding.

11. The easel of claim 7, the horizontal support being movable within an aperture at least partially defined by the vertical support.

12. A method of producing one or more easels, comprising:
die cutting a backer web associated with a backer web roll to define a support structure, the backer web comprising a front face and a back face;
at least one of printing or imaging a display web associated with a display web roll, the display web comprising a front face and a back face;
applying a first adhesive pattern to the front face of the backer web or the back face of the display web;
coupling the backer web and the display web;
trimming the coupled backer web and display web; and
cutting the coupled backer web and display web to separate the one or more easels.

13. The method of claim 12, further comprising adding one or more additional features to the display web, the one or more additional features including at least one of varnish, one or more labels, or an embossing.

14. The method of claim 12, further comprising die cutting a frame web to define an opening to enable the at least one of the printing or the imaging on the display web to be viewed therethrough.

15. The method of claim 14, further comprising adding one or more additional features to the frame web, the one or more additional features including at least one of varnish, one or more labels, or an embossing.

16. The method of claim 12, further comprising applying a second adhesive pattern to the front face of the display web or a back face of a frame web.

17. The method of claim 14, further comprising coupling the frame web and the coupled backer web and display web.

18. The method of claim 16, further comprising coupling a poly web and the coupled backer web and display web.

19. The method of claim 18, further comprising applying a third adhesive pattern to a front face of the poly web and coupling a back face of a frame web thereto.

20. A method of producing one or more easels, comprising:
die cutting a backer web associated with a backer web roll to define a support structure, the backer web comprising a front face and a back face;
applying a first adhesive pattern to the front face of the backer web or a back face of a frame web, the frame web associated with a frame web roll;
coupling the backer web and the frame web; and
defining an opening between the backer web and the frame web to enable an object to be inserted therebetween.

21. The method of claim 20, further comprising coupling a poly web to the front face of the backer web.

22. The method of claim 21, further comprising applying a second adhesive pattern to the poly web and coupling the frame web thereto.

23. The method of claim 20, further comprising at least one of printing or imaging a display web.

24. The method of claim 23, further comprising coupling the display web to the front face of the backer web.

25. The method of claim 24, further comprising applying a second adhesive pattern to a front face of the display web and coupling at least one of the frame web or a poly web thereto.
